(19) United States
(12) Patent Application Publication
(10) Pub. No.: US 2026/0236897 A1
(43) Pub. Date: Aug. 13, 2026

(54) METHOD AND SYSTEM FOR MONETIZING THE CONSUMPTION OF GOODS AND SERVICES USING BLOCKCHAIN CONTRACTS AND CONSUMER EARNED TOKENS (CETEs)

(71) Applicant: DIGIPIE INTERNATIONAL PBC, Chicago, IL (US)

(72) Inventor: Bruce Roland Davis, Chicago, IL (US)

(73) Assignee: DIGIPIE INTERNATIONAL PBC, Chicago, IL (US)

(21) Appl. No.: 19/160,463

(22) PCT Filed: Feb. 12, 2024
(86) PCT No.: PCT/US2023/077664

§ 371 Date: Aug. 27, 2025

Related U.S. Application Data
(60) Provisional application No. 63/448,669, filed on Feb. 28, 2023.

(51) Int. Cl. G06Q 20/06; G06Q 20/36

(52) U.S. Cl. CPC G06Q 20/065; G06Q 20/36; G06Q 2220/00

(57) ABSTRACT

The present disclosure relates to computer-managed systems and methods for generating, distributing, and managing Consumer Earned Tokens (CETEs) as proprietary restricted digital assets that monetize consumer spending, while avoiding speculation. The present disclosure relates to computer-managed systems and methods for generating, distributing, and managing Consumer Earned Tokens (CETEs) as proprietary restricted digital assets that monetize consumer spending while avoiding speculation. The system comprises a compliance engine configured to enforce region-specific rules, a loyalty engine configured to associate consumer expenditures with reward pledges, and a tokenization engine configured to convert fiat-denominated rewards into restricted CETEs recorded on a private blockchain-based exchange. Unlike conventional loyalty systems or speculative token platforms, CETEs are initially owned by consumers, may be registered at the family-unit level, and are designed to galvanize households, communities, and nations through stakeholding, peer-review governance, and socio-economic incentives such as crime reduction, education, and community investment. CETEs function as non-speculative instruments intended for private distribution to accredited and institutional investors under securities regulations, enabling sustainable, inclusive economic growth.

### CROSS-REFERENCE TO RELATED APPLICATIONS

This application is the US national phase of PCT Application No. PCT/US2023/077664, filed Feb. 12, 2024, which claims priority to and the benefit of U.S. Provisional Patent Application No. 63/448,669, filed Feb. 28, 2023, each of which is incorporated herein by reference in its entirety.

### TECHNICAL FIELD

The present disclosure relates to a computer-managed system implementing Consumer Earned Token Exchanges (CETEs) and for the production and private distribution of CETE tokens for users (e.g., consumers) to participate in the growth equations of emerging economies and established economies without engaging in speculation.

### BACKGROUND

Digital asset ecosystems have evolved to include a wide range of technologies such as cryptocurrencies, non-fungible tokens (NFTs), and tokenized securities. These systems often rely on public blockchains and decentralized exchanges to facilitate peer-to-peer transactions. While such platforms have introduced novel mechanisms for asset creation and transfer, they remain largely speculative and are frequently subject to regulatory scrutiny.

Loyalty reward systems have also proliferated across industries, enabling businesses to incentivize consumer behavior through point-based schemes, discounts, and promotional credits. These systems are typically siloed, lacking interoperability and transparency. Moreover, they do not provide consumers with ownership of tradable digital assets, nor do they integrate with regulated financial infrastructures.

Several patents disclose systems for managing digital assets and loyalty rewards. For example, U.S. Pat. No. 10,339,537 B2 describes a platform for capturing regulatory rules and applying them to digital asset transactions. However, this system does not integrate asset generation with consumer reward mechanisms. U.S. Pat. No. 10,482,488 B2 discloses a loyalty system that tracks consumer behavior but does not incorporate blockchain or asset conversion features. U.S. Pat. No. 11,704,733 B2 describes multi-asset tokens but lacks a method for linking consumer rewards to asset creation or distribution.

### SUMMARY

Disclosed herein are systems and methods capable of addressing the above-described shortcomings and may also provide any number of additional or alternative benefits and advantages. Embodiments disclosed herein include systems and methods for facilitating the generation and distribution of digital assets in connection with consumer behavior and business incentives. The system comprises a loyalty engine configured to track consumer expenditures and business pledges, a compliance engine configured to monitor regulatory obligations and enforce business conduct, and a tokenization engine configured to convert fiat-denominated rewards into restricted digital assets. The computing system may include a private trading platform configured to manage the issuance and transfer of digital assets in accordance with regulatory constraints. The system may further include a user interface configured to present reward balances, transaction histories, and compliance statuses to consumers and business entities.

In certain embodiments, the computing system comprises a modular architecture implemented as a software-as-a-service (SaaS) platform. The architecture includes a rule-based compliance engine configured to retrieve jurisdiction-specific or region-specific regulatory parameters and apply automated evaluations to business conduct and consumer transactions. The compliance engine executes real-time alert protocols upon detecting deviations from predefined thresholds, thereby improving regulatory oversight and reducing latency in compliance enforcement. A tokenization engine operates on a secure computing node and applies asset validation logic to construct digital tokens comprising structured data and smart contracts. Each smart contract encodes restriction conditions and compliance hooks, which are verified prior to listing on a private blockchain-based exchange. The system further includes a distributed ledger configured to record token issuance, transfer events, and audit logs using consensus operations such as proof-of-stake or proof-of-work.

In some embodiments, the computing system comprises a rule-based engine configured to apply regulatory rules to business conduct and consumer transactions. The rule-based engine may be configured to generate alerts, initiate audits, and enforce trading restrictions based on predefined compliance parameters. The computing system may further comprise a blockchain-based ledger configured to record asset issuance, transfer events, and compliance actions. The computing system may be implemented as a SaaS platform and may be configured to operate at national scale. The system may be modular and interoperable with existing financial infrastructures, regulatory databases, and consumer-facing applications.

In some aspects, the techniques described herein relate to a computer-implemented method executed for managing digital tokens based on consumption activity, the method including: receiving, by a computer, registration data from a plurality of remote computing devices associated with entities and users via a network interface; verifying, by the computer, the registration data against region-specific compliance parameters stored in a rule set database; generating, by the computer, a compliance profile for each entity and user whose registration data satisfies the compliance parameters, wherein each compliance profile includes a unique identifier and a set of operational constraints; extracting, by the computer, usage records from a plurality of computing devices associated with consumption activity and declared contribution metrics; parsing, by the computer, the usage records to identify consumption values, timestamps, source identifiers, and contribution metrics; storing, by the computer, the parsed usage data in a structured database indexed by user identifier and time interval; calculating, by the computer, a reward metric based on the parsed usage data that correlates consumption activity with token generation parameters; generating, by the computer, a digital token including a data structure and a smart contract encoded with conditional logic; transmitting, by the computer, the digital token to a private blockchain-based exchange platform hosted on a secure computing node; and recording, by the computer, the usage records and compliance profiles on a blockchain.

In some aspects, the techniques described herein relate to a method, further including: executing, by the computer, a rule-based evaluation of operational metrics associated with the compliance profiles; generating, by the computer, a compliance alert in response to detecting a deviation from a predefined threshold; and transmitting, by the computer, the compliance alert to a supervisory computing device configured to receive compliance notifications.

In some aspects, the techniques described herein relate to a method, further including: retrieving, by the computer, updated compliance parameters from a remote data source hosted on a third-party server; and updating, by the computer, the region-specific rule set stored in a local memory.

In some aspects, the techniques described herein relate to a method, further including: verifying, by the computer, identity credentials of a user using a multi-factor authentication protocol; encrypting, by the computer, the verified identity credentials using a cryptographic algorithm; and storing, by the computer, the encrypted identity credentials in a secure data store accessible to a compliance engine.

In some aspects, the techniques described herein relate to a method, wherein the extracting the usage records from the plurality of computing devices includes: receiving, by the computer, usage data from a point-of-interaction device; parsing, by the computer, the usage data to identify a source identifier, a timestamp, and a consumption value; and associating, by the computer, the parsed usage data with a user identifier.

In some aspects, the techniques described herein relate to a method, wherein the calculating the reward metric includes: executing, by the computer, a mathematical model that applies a weighting factor to the consumption value based on a declared contribution metric associated with an entity; and generating, by the computer, a reward metric based on the weighted consumption value.

In some aspects, the techniques described herein relate to a method, wherein the generating digital token includes: assembling, by the computer, a digital token including a data structure and a smart contract; encoding, by the computer, the smart contract with a restriction condition; and assigning, by the computer, the digital token to a user account stored in a distributed ledger.

In some aspects, the techniques described herein relate to a method, further including: executing, by the computer, a verification of a restriction condition associated with the digital token; and enabling, by the computer, the digital token to be listed on a private blockchain-based exchange platform hosted on a secure computing node in response to the restriction condition being satisfied.

In some aspects, the techniques described herein relate to a method, further including: recording, by the computer, a digital token event on a blockchain using a consensus operation selected from the group consisting of proof-of-stake and proof-of-work.

In some aspects, the techniques described herein relate to a method, further including: generating, by the computer, an audit log including a timestamp, a token identifier, and a compliance status; and recording, by the computer, the audit log on a blockchain.

In some aspects, the techniques described herein relate to a system for managing digital tokens based on consumption activity, the system including: a computer including a processor, configured to: receive registration data from a plurality of remote computing devices associated with entities and users via a network interface; verify the registration data against region-specific compliance parameters stored in a rule set database; generate a compliance profile for each entity and user whose registration data satisfies the compliance parameters, wherein each compliance profile includes a unique identifier and a set of operational constraints; extract usage records from a plurality of computing devices associated with consumption activity and declared contribution metrics; parse the usage records to identify consumption values, timestamps, source identifiers, and contribution metrics; store the parsed usage data in a structured database indexed by user identifier and time interval; calculate a reward metric based on the parsed usage data that correlates consumption activity with token generation parameters; generate a digital token including a data structure and a smart contract encoded with conditional logic; transmit the digital token to a private blockchain-based exchange platform hosted on a secure computing node; and record the usage records and compliance profiles on a blockchain.

In some aspects, the techniques described herein relate to a system, wherein the computer is further configured to: execute a rule-based evaluation of operational metrics associated with the compliance profiles; generate a compliance alert in response to detecting a deviation from a predefined threshold; and transmit the compliance alert to a supervisory computing device configured to receive compliance notifications.

In some aspects, the techniques described herein relate to a system, wherein the computer is further configured to: retrieve updated compliance parameters from a remote data source hosted on a third-party server; and update the region-specific rule set stored in the rule set database.

In some aspects, the techniques described herein relate to a system, wherein the computer is further configured to: verify identity credentials of a user using a multi-factor authentication protocol; encrypt the verified identity credentials using a cryptographic algorithm; and store the encrypted identity credentials in a secure data store accessible to a compliance engine.

In some aspects, the techniques described herein relate to a system, wherein the computer is further configured to: receive usage data from a point-of-interaction device; parse the usage data to identify a source identifier, a timestamp, and a consumption value; and associate the parsed usage data with a user identifier.

In some aspects, the techniques described herein relate to a system, wherein the computer is further configured to: apply a weighting factor to the consumption value based on a declared contribution metric associated with an entity; and generate the reward metric based on the weighted consumption value.

In some aspects, the techniques described herein relate to a system, wherein the computer is further configured to: assemble the digital token including a data structure and a smart contract; encode the smart contract with a restriction condition; and assign the digital token to a user account stored in a distributed ledger.

In some aspects, the techniques described herein relate to a system, wherein the computer is further configured to: verify a restriction condition associated with the digital token; and enable the digital token to be listed on the private blockchain-based exchange platform in response to the restriction condition being satisfied.

In some aspects, the techniques described herein relate to a system, wherein the computer is further configured to: record a digital token event on the blockchain using a consensus operation including at least one of proof-of-stake or proof-of-work.

In some aspects, the techniques described herein relate to a system, wherein the computer is further configured to: generate an audit log including a timestamp, a token identifier, and a compliance status; and record the audit log on the blockchain.

Embodiments may include method and system for monetizing the consumption of goods and services 110 using the blockchain and Consumer Earned Tokens (CETEs), that comprises three primary Saas embodiments: a computer-managed system of automated compliance software for in-network entities within the SRO layer and for the screening and registration of compliant in-network consumers on the public platform layer; a computer-managed system for in-network consumer expenditures tracking, business entity loyalty pledges and resulting fiat reward calculations within quarterly or other recurring time periods comprising methods for measuring consumerism in mathematical equations against rewards-based opportunities for random growth of digital assets in the form of CETEs; a computer-managed system for converting the rewards to CETES to reside on the private CETE exchange and blockchain based alternative trading system (ATS), available to pre-authorized traders only, aimed at creating a self-perpetuating consumption and growth modeled economy for the potential international general populace of peoples, wherever the system is applied, without speculation.

The systems and methods may comprise software as a service methodology to provide a computer-managed automated system for regulatory compliance by member entities within the SRO layer of the digital 114 infrastructure and the software embodiment includes algorithms and rule-based engines that regularly assess compliance metrics so when noncompliance issues are detected, the system generates real-time alerts to the relevant entities and regulatory monitors within the SRO. The systems and methods may comprise The systems and methods may comprise software as a service methodology to provide a computer-managed system designed to adapt to changing regulations in programmed international regulatory authorities by regularly updating international rule sets and compliance criteria for the programmed jurisdictions.

The systems and methods may comprise software as a service methodology to provide a computer-managed system that provides a user friendly interface for onboarding and vetting compliant in-network consumers including identity verification, background checks, and the collection of other necessary documentation; whereas during the registration process, the system conducts initial compliance verifications to ensure that consumers meet the regulatory criteria for participation in the network while comprising robust data encryption and security measures to protect sensitive consumer information and regulatory data.

Consumers may register as family units or an equivalent, with verifiable legal documentation and/or legal guardianship, family trust documentation or the international equivalents of the aforementioned documentation establishing a legal family entity or the equivalent for combined expenditures tracking.

The systems and methods may comprise software as a service methodology to provide a computer-managed system comprising multiple functions, including monitoring and tracking consumer expenditures, facilitating entity pledges, and rewarding consumer participants with fiat currency based on their activities within the network whereas the system continuously monitors consumer transactions within the network as it captures and records data related to purchases, payments, entity pledges and network financial activities.

Consumer spending is weighed against entity pledges in quarterly or other pre-set recurring calendar cycles in order to calculate fiat rewards due consumers within said calendar period.

The systems and methods may comprise software as a service methodology to provide a computer-managed system comprising multiple system functions for consumer registrants as a mobile app.

Fiat rewards due consumers are converted to CETEs comprising smart contracts, stocks, commodities, tokens, cryptocurrencies, or any other tradable assets comprising the underlying assets within CETEs and defined as restricted securities as assembled by brokers and/or market makers on the private alternative trading system on behalf of in-network consumers.

Master CETEs are created by the brokers and/or market makers comprising similar underlying assets to be cloned and assigned to each in-network consumer account according to the rewards due the consumer(s) within the calendar period.

The systems and methods may comprise software as a service methodology to provide a computer-managed system comprising a private blockchain based high frequency alternative trading system for listing the CETEs which are initially owned by the consumers who earned them while deemed restricted until the terms within the accompanying smart contracts have been satisfied at which time the CETEs may then be bought by preauthorized traders only on the CETEs platform.

The systems and methods may comprise software as a service methodology to provide a computer-managed system comprising a private 127 blockchain based high frequency alternative trading system for CETEs as a mobile application.

The systems and methods may comprise software as a service methodology to provide a computer-managed system comprising a private blockchain based high frequency alternative trading system with API futures for potential secondary markets for trading CETEs.

The systems and methods may comprise software as a service methodology to provide a computer-managed system that enables in-network entities to set terms and conditions for rewards through pledging that encourages peer to peer scrutiny of social contracts among in-network consumers.

The systems and methods may comprise as a service methodology to provide a computer-managed system that enables in-network entities to set terms and conditions for rewards through pledging to better control crime in distressed communities by enabling in-network consumer stake-holding within stated calendar periods.

The systems and methods may comprise software as a service methodology to provide a computer-managed system that enables a nation state to overlay this novel digital infrastructure over or alongside its existing economic superstructure to better provide transparency and productive outcomes to the peoples of the nation who choose to be in-network.

The systems and methods may comprise software as a service methodology to provide a computer-managed system that enables a nation state to overlay this novel digital infrastructure over or alongside its existing economic superstructure to better allocate the wealth of the nation to the in-network consumers who support the economy through consumerism.

The systems and methods may comprise software as a service methodology to provide a computer-managed system that enables nations to better measure and better grow the assets of that nation-state as the measures can include the cumulative value of its in-network consumers and all that they own through the novel digital infrastructure.

The systems and methods may comprise software as a service methodology to provide a computer-managed system whereby sharing in the wealth of the nation's economy is a birthright of its in-network consumers as manifested by the monetization of their consumption from birth.

The systems and methods may comprise software as a service methodology to provide a computer-managed system for monetizing the consumption of goods and services using the blockchain and Consumer Earned Tokens (CETEs), that comprises novel methods for providing the international general populace with new forms of market-based ownership, hope and potential economic growth, without speculation.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 depicts dataflow amongst components of a system, according to embodiments.

FIG. 2 is an embodiment of the automated computer managed compliance system, according to embodiments.

FIG. 3 is an embodiment of a process for creating CETEs comprising a variety of tradeable assets, according to embodiments.

FIG. 4 is an embodiment of the automated consumer compliance method leading to in-network consumer status, according to embodiments.

FIG. 5 is an embodiment of order flow of a pre-authorized trader operating on a private platform, according to embodiments.

FIG. 6 is an embodiment of a consumer offering to sell a CETE(s) to pre-authorized traders after restrictions have been satisfied on the platform, according to embodiments.

FIG. 7 is an embodiment of a trading platform having CETEs performing an order reporting process to regulatory organizations, according to embodiments.

FIG. 8 is a flowchart depicting operations of a computer-implemented method for managing digital tokens based on consumption activity, according to embodiments.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Human socio-economic systems that use currencies can be diverse and varied, reflecting the complexities of different societies and their economic structures. In a market economy, individuals and businesses interact through voluntary exchange of goods and services. Currencies, such as fiat money or digital currencies serve as mediums of exchange, facilitating transactions and trade. Prices are determined by supply and demand dynamics, and market forces shape resource allocation and production decisions. Capitalism is an economic system characterized by private ownership of resources and means of production. Currencies play a central role in facilitating the accumulation, investment, and distribution of capital.

Profit-seeking individuals and enterprises utilize currencies to engage in economic activities, while markets and competition influence resource allocation and wealth creation. In socialist systems, the means of production are owned or controlled by the state or the community as a whole. Currencies are often employed to enable economic transactions and distributions of goods and services. However, the emphasis is placed on collective ownership, equitable distribution, and public welfare rather than individual profit maximization. Many modern economies exhibit characteristics of both market economies and planned economies.

Governments play a significant role in areas such as regulation, public services, and social welfare, while private enterprises operate within a market-based framework. Currencies facilitate exchanges between public and private sectors, as well as between individuals and businesses. In some societies, a gift economy operates alongside or in place of market-based transactions. Currencies may not be used in the conventional sense, as the focus is on reciprocal giving and sharing without immediate expectation of return. Non-monetary units, such as favors, goodwill, or social status, can function as currencies in these systems.

Complimentary currencies are designed to supplement or complement national currencies, aiming to address specific economic or social objectives. Examples include community currencies, time-based currencies, or local exchange trading systems (LETS). These currencies facilitate localized transactions, encourage community cooperation, and promote economic resilience. Islamic financial systems are guided by Sharia law principles, which prohibit the payment or receipt of interest (riba) and promote ethical and socially responsible practices. Islamic banking institutions utilize currencies compliant with Islamic principles, such as Islamic gold dinars or silver dirhams, and employ various financial instruments that adhere to specific rules and restrictions. And now, humanity has blockchain technologies to potentially change the entire world's economic landscapes.

The primary purpose for CETEs is to generate wealth and potential growth to the general populace-without speculation, as new forms of market-based ownership, by way of digital assets. This method and system provide a groundbreaking approach to monetize consumption while promoting significant economic growth. By integrating blockchain contracts and CETEs into a self-perpetuating consumption and growth modeled economy, this invention creates a dynamic and participatory ecosystem that rewards consumers, stimulates innovation, and drives economic prosperity.

Blockchain technologies play a crucial role in making digital assets possible by providing a secure and hybrid decentralized platform for their creation, ownership, and transfer. Blockchain platforms like Ethereum support the execution of smart contracts, which are self-executing agreements with predefined rules and conditions. Smart contracts enable the automation of digital asset transfers, ensuring that ownership is transferred only when specified conditions are met. They eliminate the need for intermediaries and provide trustless and tamper-proof execution of asset-related agreements.

However, the administration of the overall infrastructure may be better served by being centralized which brings about a scenario of a hybrid economic ecosystem of community engagements. The introduction and commercialization of artificial intelligence, further automation, blockchains and other technological advances is signaling humanity to re-think financial systems to keep pace with the advances for the good of the whole and to ensure that humans have viable options for thriving in spite of automation and AI. While cryptocurrencies have surpassed a trillion-dollar market capitalization, that version of digital assets faces many regulatory hurdles and much volatility before reaching mass adoption and especially institutional acceptance, if ever.

CETE tokens are tokenized digital assets produced whose primary purpose is to generate wealth and growth to the general populace—without speculation. CETEs were designed to neutralize most SEC concerns regarding digital assets, CETEs were designed as Rule 506 Reg D exemptions—restricted securities, CETEs are initially owned by the consumers who make markets what they are, CETEs were designed for private sales to accredited and institutional investors, CETEs were designed to galvanize all communities as true stakeholders, CETES were designed to facilitate self-perpetuating local, regional and/or national growth economies, CETEs may be created with many combinations of underlying assets by broker dealer market makers, CETEs are designed to bridge the gaps between digital assets, equities, and other stores of value including smart social contracts between people, CETEs are designed to give business entities the ability to implement peer pressure measures to better control crime in distressed communities, CETEs are designed to empower everyday people with pride of ownership mentalities versus an us against them mindset, CETEs are inclusive by default, CETEs will lead to a new national narrative of unity through ownership.

The present disclosure relates to a computer-managed system for the production and private distribution of CETEs upon a proprietary digital infrastructure comprised of novel methods that enable consumers to participate in the growth equations of emerging economies as well as established economies—without speculation.

Currently, multiple nation's central banks are transitioning to or pondering a digital currency also known as CBDC (central bank digital currency). Digital assets can go hand in hand with a CBDC and growth economy, except that they may be primarily market based instead of being directly controlled by governments.

This scenario creates a plethora of opportunities to innovate the digital fintech space in novel and productive ways in anticipation of the changing economic conditions throughout the world such as the commercialization of artificial intelligence which may cause a major dilemma for many humans who may be unable to earn a living as previously defined. The creation of CETEs is a pivotal moment because prior fintech art, cryptocurrencies, NFTs and other digital applications have not addressed monetizing the consumption of goods and services using the blockchain and digital assets within current regulatory parameters.

CETEs were designed to neutralize most SEC concerns regarding digital assets as CETEs will only be available on the private exchange on which they were created. CETEs will provide human beings with self-perpetuating alternative sources for generating wealth and inclusion within growth economies as new forms of market-based ownership. Providing new forms of speculation is the underlying primary purpose for the production and private distribution of novel CETEs. Consumers will of ownership for the general populace without be encouraged to register as family units or an equivalent.

The emergence of blockchain technologies and related applications such as cryptocurrencies, NFTs, smart contracts and other on chain applications may likely disrupt economies in a variety of productive ways. However, prior art in this field has not yet produced a method and system that enables consumers to monetize their consumption of goods and services by generating passive income from spending habits that reward new forms of ownership, as CETEs.

Beginning with the method and system's automated compliance layer for the digital infrastructure or network, prior art in this field also does not address the value of integrating automated compliance mechanisms within a computer managed loyalty system that generates new forms of digital ownership in compliance with predetermined parameters within a predetermined regulatory environment. U.S. Pat. No. 10,339,537B2, Tata Consultancy et al, describes a system that captures regulatory rules provided by a regulatory body for an organization etcetera, however, 537B2 does not claim integration within a digital infrastructure for determining compliance of digital assets being produced and distributed upon a private network. Furthermore, 537B2 methods alone do not support the production and distribution of proprietary digital assets invented as CETEs.

Continuing on to the loyalty spending layer for the digital infrastructure, U.S. Pat. No. 10,482,488B2, Target Brands, Inc. et al, teaches systems and methods for providing a loyalty and rewards system. However, 488B2 does not teach a method and system for monetizing consumption using blockchain contracts and proprietary digital assets as rewards while in automated compliance with designated regulatory agencies.

Continuing on to the proprietary digital assets layer, U.S. Pat. No. U.S. Pat. No. 11,704,733B2, Tzero IP LLC et al teaches multiple assets within a digital token, however, 733B2 does not claim a method and system for monetizing consumption using blockchain contracts and CETEs which would require novel methods of digital asset acquisition and automated regulatory compliance not claimed in the previously referenced prior art.

While there may be other distinctions that differentiate the subject method and system from prior art to someone skilled in the art, the previously described distinctions are glaring indications of novelty. Along with the aforementioned glaring indications of novelty, there are several enabling and overlapping prior art references that should be acknowledged; in the field of trading derivative securities, U.S. Pat. No. 8,204,816B2, to Chicago Board Options Exchange et al; in the field of loyalty programs, AU Pat. No. 2013206026B2 to Visa International Service Association et al; in the field of digital token exchanges, U.S. Pat. No. 10,225,085B2, to Unity IPR ApS et al; in the field of digital wallets, U.S. Pat. No. 10,755,241B2, to Coinbase, Inc. et al; in the field of EFT investing, U.S. Pat. No. 8,719,138B2, to State Street Corporation et al, and by these references the preceding and listed patents are hereby incorporated in their entirety.

CETEs produced by the Consumers Earned Token Exchange Inc, are proprietary digital assets aimed at promoting widespread wealth and growth while avoiding speculation. CETEs address regulatory concerns regarding digital assets and adhere to restricted securities exemptions and they are initially owned by consumers. CETEs are intended for private sales to accredited and institutional investors, fostering community engagement, self-perpetuating and self-sustaining local, regional, and national economies. They can incorporate various underlying assets and bridge the gap between digital assets, equities, commodities, and other stores of value now known or later found. CETEs will empower in-network business entities to mitigate crime in distressed communities by enabling pride of ownership mindsets and productive peer pressure review among consumers. CETEs will promote inclusivity and aspire to create a national narrative of unity through new forms of market-based ownership wherever the method and system are applied.

The system is implemented as a software-as-a-service (SaaS) platform and includes mobile applications for consumer interaction. The SaaS platform comprises modules for onboarding, token tracking, goal visualization, and compliance status. The system tracks consumption activity across multiple channels, including online marketplaces, e-commerce platforms, and physical retail environments. Consumption data is parsed and indexed by the system processor and used to calculate fiat-denominated rewards. These rewards are converted into digital tokens by market maker nodes operating on secure computing infrastructure. Each token includes or otherwise invokes a smart contract that defines restriction conditions and transfer rights. Tokens are listed on a private blockchain-based exchange and recorded on a distributed ledger. The system architecture supports partial decentralization, enabling distributed consensus for transaction validation while retaining centralized control over administrative functions and regulatory overlays.

Consumers may register as family units or an equivalent. The computerized system tracks and records registered user's consumption activities across various platforms, such as online marketplaces, e-commerce websites, physical stores, real estate rentals and the like. This tracking mechanism gathers data on in-network.

The present disclosure relates to a computer-managed system for the production and private distribution of CETEs upon a proprietary digital infrastructure comprised of novel methods that enable consumers to participate in the growth equations of emerging economies as well as established economies-without speculation.

Through software as a service (SaaS) and mobile apps, the method and system provide a framework for consumers to monetize their consumption habits by leveraging blockchain technology and a proprietary system of Consumer Earned Tokens (CETEs) produced and privately distributed upon a private alternative trading platform (ATS) for CETEs, also known as the Consumers Earned Token Exchange, (CETE). CETEs may comprise smart contracts, stocks, commodities, tokens, cryptocurrencies, or any other tradable assets, resulting in restricted securities as defined within the accompanying smart blockchain contracts. CETEs are created by the system's proprietary market makers on behalf of the business entities within the proprietary network desiring to reward their customer bases with proprietary digital assets. The business entities must also be registered members of the digital infrastructure's self-regulatory organization (SRO) which includes automated regulatory compliance and monitoring for the entire digital infrastructure. CETEs are initially owned by the in-network consumers of goods and services until the restrictions within the accompanying smart contracts have been satisfied at which time they may be held or sold on the private CETE trading platform.

Consumers may register as family units or an equivalent. The computerized system tracks and records registered user's consumption activities across various platforms, such as online marketplaces, e-commerce websites, physical stores, real estate rentals and the like. This tracking mechanism gathers data on in-network consumer spending, rentals, browsing behavior, preferences, and other relevant information and data that may also be co-managed and monetized by the user base through the proprietary system. Based on the tracked consumption activities, consumers earn fiat capital in their preferred currency as rewards from registered in-network business entities which are then converted to CETEs by the system's market makers before private distribution on the private exchange. The computerized system applies predetermined criteria to calculate the fiat rewards, considering factors like the value of purchases, frequency of engagement, brand loyalty, or other specified metrics set and determined by the issuing business entities within the network.

The system utilizes blockchain technology to securely store and manage the transactions and token balances for the consumer owners of the tokens. The system ensures transparency, immutability, and partial blockchain decentralization, enabling trust and preventing unauthorized modifications to the transaction records. In a partially decentralized system, certain aspects or components may be decentralized, while others remain centralized. This hybrid approach is being adopted to balance the benefits of decentralization, such as increased transparency, security, and resilience, with the need for some level of coordination, efficiency, and oversight that centralization can provide within a proprietary digital infrastructure within a regulatory environment. The specific characteristics and degree of decentralization in a partially decentralized system can vary depending on the context. For example, in the context of blockchain technology, a partially decentralized network may have a distributed consensus mechanism, where multiple nodes participate in validating and recording transactions, while certain administrative functions or governance decisions are still centralized.

To ensure widespread adoption and the efficient functioning of CETEs, the solution involves collaborating with established market makers and other prominent financial institutions. Their involvement will facilitate significant transaction volumes, resulting in significant wealth generation for the general populace without speculation. By harnessing the power of CETEs, individuals can accumulate wealth and new forms of market-based ownership without relying on standard speculative investment practices. To ensure compliance and to foster a fair and secure environment, the invention proposes the establishment of a self-regulatory organization (SRO) as an integral part of the digital infrastructure. This organization will define and enforce the rules and regulations governing the operations of the novel digital infrastructure and ecosystem, providing a framework for the safe and reliable participation in compliance with applicable government regulations and will feature automated regulatory compliance monitoring for the entire digital infrastructure.

Furthermore, the present invention relates to a fintech solution aimed at addressing the wealth disparity prevalent in stock market ownership all over the world. For example, as of 2021, the bottom 90% of households in the United States held a mere 11.2% of the country's total stock market wealth. The situation is even more severe in other parts of the world. To address this issue and promote economic growth, hope, and new forms of market-based ownership for the general populace without relying on speculation, the proposed invention leverages blockchain technology and establishes the CETE, which is where the proprietary CETEs are created on behalf of the general populace who are then rewarded random growth opportunities, for supporting the economy. And as further described within, the method and system also provide business entities within the network that have intentions of re-incentivizing positive socio-economic behavioral patterns within distressed communities, with tools and abilities to set local terms and conditions for rewards.

CETEs may likely cause communities to raise standards of living as peer pressures evolve to reveal mutual dependencies and mutual benefits from lower crime rates, higher moral standards, and higher literacy rates to name a few potential goals among the business entities and the new and true stakeholders of the economies, we the people. For example, CETEs were designed as Rule 506 Reg D exemptions—restricted securities and therefore subject to FINRA, SEC oversight in the U.S. however, the SaaS is also designed to accommodate variations of regulatory compliance for any nation or authority desiring the benefits of a self-perpetuating growth economy for its peoples. The distribution of CETEs is private by design on each nation's Consumers Earned Token Exchange private platform however, there is the possibility of secondary market activity after the fact.

The computing system described herein introduces a non-conventional architecture for managing digital tokens based on consumption activity. Unlike conventional loyalty or asset tracking systems, the disclosed system integrates a compliance engine configured to retrieve jurisdiction-specific rule sets via secure APIs and apply machine learning algorithms to detect anomalous patterns in consumption and transaction data. This engine improves regulatory monitoring by automating rule enforcement and generating structured alerts with metadata including timestamp, rule violated, and severity index. These alerts are transmitted to regulatory endpoints using encrypted channels, thereby enhancing the system's ability to maintain real-time compliance across jurisdictions.

The computing system described herein introduces a non-conventional architecture for managing digital tokens based on consumption activity. Unlike conventional loyalty or digital asset tracking systems, the disclosed system integrates a compliance engine configured to retrieve jurisdiction-specific rule sets via secure APIs and apply machine learning algorithms to detect anomalous patterns in consumption and transaction data. This engine improves regulatory monitoring by automating rule enforcement and generating structured alerts with metadata including timestamp, rule violated, and severity index. These alerts are transmitted to regulatory endpoints using encrypted channels, thereby enhancing the system's ability to maintain real-time compliance across jurisdictions (or regions).

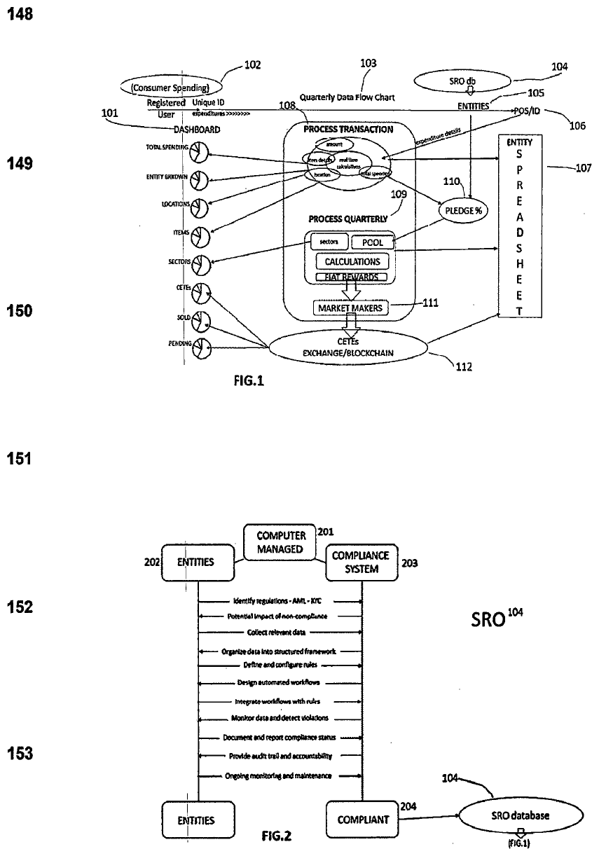

FIG. 1 depicts dataflow amongst components of a system 100 as a dashboard for registered consumers to track the processes of the system 100 as the system 100 executes operations that apply to the user accounts as consumer spending 102 represents the registration, KYC-AML compliance and assigning of a unique identifier for the consumer account to be tracked as quarterly flowchart 103 that includes a quarterly method of cycling through the processes of consumer expenditure tracking, entity pledge tracking, rewards tracking and conversion to CETEs tracking and exchange listings—then repeating. The self-regulatory organization (SRO) database 104 of already compliant registered entities 105 and is the point of sale (POS) identifier (ID) (POS ID 106) generated by an entity for a transaction operation 108 to be processed. During the transaction operations 108, details, such as amounts, item details, and other data, are distributed to the consumer dashboard 101 pies and an entity spreadsheet 107 and the total spend is factored with the entity pledge amount 110 and that result is passed to a processes for quarterly operations 109 pool, to be included within the quarterly calculations as rewarded fiat capital from an entity to the consumer, which is then converted to CETEs by the exchange's market makers 111 and/or broker dealers. Upon conversion, the CETEs are then listed on the exchange and recorded on the blockchain 112.

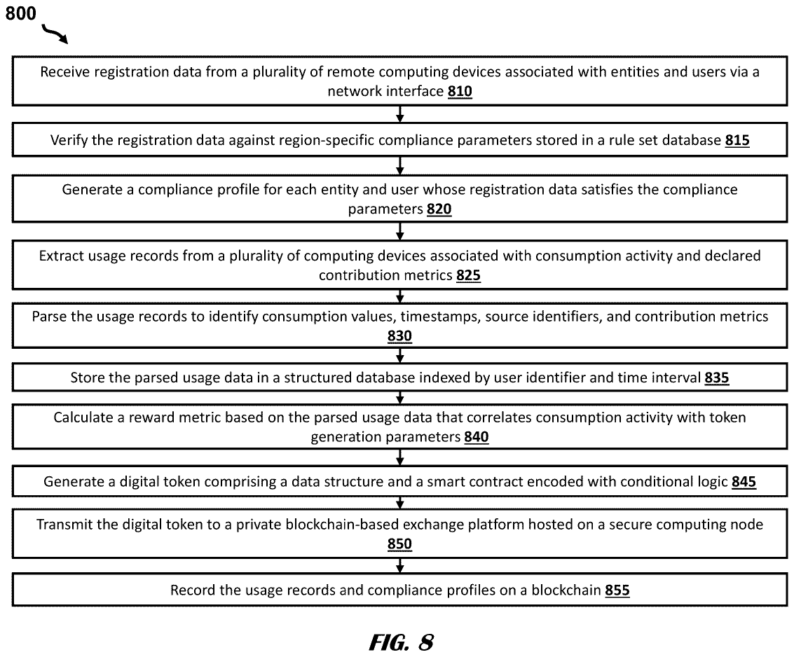

The system 100 comprises a computer-implemented infrastructure including a processor, memory, and network interface configured to execute software modules for managing digital tokens based on consumption activity. The system 100 includes components for data ingestion, compliance verification, token generation, and blockchain recording. The components of the system 100 may include any number of computing devices (e.g., server computers) having a processor, memory, and network interface configured to execute software modules for managing digital tokens based on consumption activity. The system 100 includes, with reference to FIG. 7, a compliance engine 707, a tokenization engine 714, a smart contract manager 728, and a blockchain interface 112. Compliance engine 707 retrieves rule sets from external regulatory databases via secure APIs and applies machine learning algorithms to detect anomalous patterns in consumption and transaction data. Upon detection, compliance engine 707 transmits structured alerts to regulatory endpoints 706. Tokenization engine 714 constructs digital tokens using asset composition rules and metadata tagging, and interacts with smart contract manager 728 to encode restriction conditions. Smart contract manager 728 validates contract integrity and stores lifecycle metadata in a registry 729. Blockchain interface 112 records token events and compliance actions using a distributed consensus mechanism.

Turning back to FIG. 1, the consumer dashboard 101 comprises a graphical user interface rendered by a web-based or mobile application executing on a user device. The dashboard 101 is configured to display consumption metrics, token balances, and compliance status. The dashboard 101 receives data from backend services via secure API calls.

Consumer spending 102 comprises structured data records generated by point-of-interaction devices and transmitted to the system 100 via secure communication protocols. The data includes timestamped entries representing consumption activity, which are parsed and indexed by the system processor.

Quarterly flowchart 103 comprises a software module configured to execute time-based logic for aggregating consumption data, contribution metrics, and reward calculations over predefined calendar intervals. The flowchart 103 invokes subroutines for compliance verification, token generation, and exchange listing.

SRO database 104 comprises a relational or distributed data store configured to maintain records of registered entities, compliance statuses, and operational constraints. The database 104 is accessed by the compliance engine via structured query language (SQL) or equivalent data access protocols.

Registered entities 105 comprise data objects stored in the SRO database 104, each object representing an entity profile including entity identifier, compliance history, and contribution parameters. The system processor accesses these objects during reward metric calculations.

Point-of-sale identifier (POS ID) 106 comprises a unique alphanumeric string generated by a merchant device during a consumption event. The POS ID 106 is transmitted to the system 100 and used to associate consumption data with a registered entity.

Entity spreadsheet 107 comprises a structured data file generated by the system processor and transmitted to entity computing devices. The spreadsheet 107 includes consumption summaries, contribution metrics, and reward allocations for each consumer associated with the entity.

Transaction operations 108 comprise executable software routines configured to process consumption data, validate POS identifiers, and update consumer dashboards. The operations 108 include parsing, normalization, and storage of consumption records.

Quarterly operations pool 109 comprises a memory-resident data structure configured to temporarily store aggregated consumption and contribution data for batch processing. The pool 109 is accessed by the reward calculation engine during scheduled execution cycles.

Entity pledge amount 110 comprises a numerical value stored in the entity profile and used as a weighting factor in reward metric calculations. The value is retrieved from the SRO database 104 and applied by the computation engine.

Market makers and/or broker dealers 111 comprise computing nodes authorized to generate digital tokens based on reward metrics. These nodes execute token generation software and interact with the blockchain interface to record token issuance events.

Blockchain 112 comprises a distributed ledger system configured to record token generation, assignment, and transfer events. The blockchain 112 is accessed via secure APIs and supports consensus operations such as proof-of-stake or proof-of-work. The blockchain interface 112 records token events and compliance actions using a distributed consensus mechanism such as proof-of-stake or proof-of-work. This interface 112 improves data integrity and auditability by maintaining a tamper-resistant ledger of token issuance, transfer, and compliance actions. The system's 100 hybrid architecture, combining centralized administrative control with decentralized ledger operations, supports scalable deployment while preserving transparency and security.

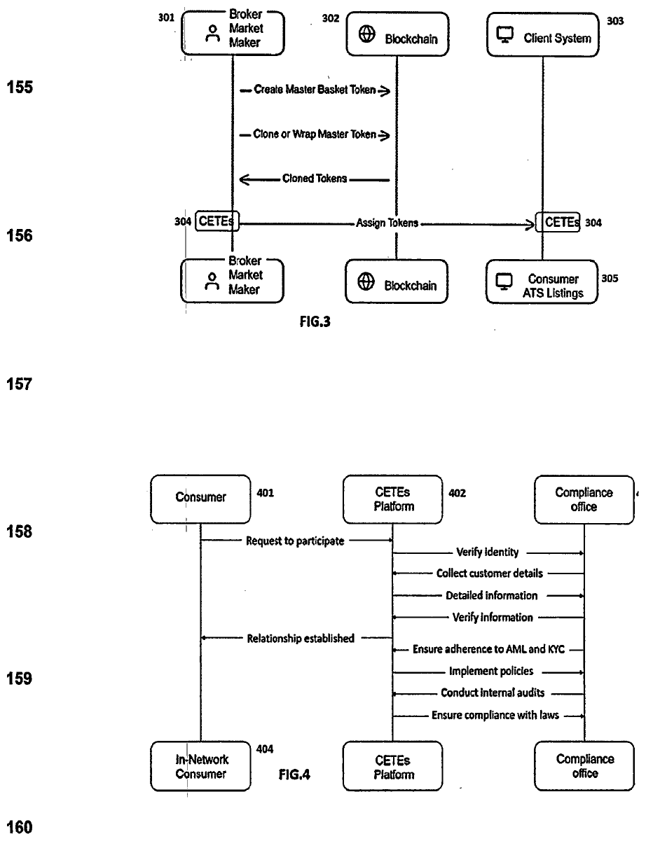

FIG. 2 is an embodiment of the automated 201 computer managed compliance system comprising member 202 entities within the self-regulatory organization SRO 102 and the various measures entities 203 must achieve to reach compliant statuses 204, in order to participate in the SRO database 104 of FIG. 1.

Automated compliance system 201 comprises a computer-managed subsystem executing on a processor configured to monitor, evaluate, and enforce operational constraints for entities participating in a digital infrastructure. The system 201 includes a rule-based engine and a compliance verification module that interface with a structured data store.

Member entities 202 comprise data objects stored in a compliance registry, each object representing a participating organization. Each entity record includes metadata such as entity identifier, registration status, and historical compliance metrics. The processor accesses these records during compliance evaluations.

Compliance measures 203 comprise a set of predefined criteria stored in a rule set database. These criteria include operational thresholds, behavioral conditions, and reporting obligations. The processor applies these measures to entity data to determine eligibility for participation in the infrastructure.

Compliant statuses 204 comprise Boolean flags or enumerated values assigned to entity records following successful evaluation against compliance measures 203. These statuses are stored in the compliance registry and used to gate access to system resources and token generation privileges.

SRO system 102 comprises a computing node configured to manage the self-regulatory organization layer of the infrastructure. The node executes software routines for entity registration, rule enforcement, and compliance reporting. The SRO system 102 interfaces with the compliance system 201 and the SRO database 104 of FIG. 1.

SRO database 104 (from FIG. 1) comprises a structured data store configured to maintain records of registered entities, compliance statuses, and operational constraints. The database 104 is accessed by the compliance engine via structured query language (SQL) or equivalent data access protocols.

FIG. 3 is an embodiment of the creation of CETEs comprising a variety of tradeable assets. Once processes 109 of FIG. 1 have been resolved, the CETE exchange market makers 301 and/or brokers create Master Basket Tokens by selecting some preferred underlying assets that match the amounts of the fiat rewards and then cloning that grouping to be CETEs 304 distributed to the consumer accounts 303 who earned them. Once the CETEs 304 have been assigned to the consumer account 303 which earned them, the CETEs 304 are listed on the Exchange 305 but may not be sold until the restrictions have been satisfied via the accompanying smart contracts 302.

CETE exchange market makers and/or brokers 301 comprise computing nodes authorized to generate digital tokens based on reward metrics. Each node includes a processor configured to execute token assembly routines and asset selection algorithms. The nodes interface with asset databases and compliance modules to construct token payloads.

Smart contracts 302 comprise executable code segments stored on a blockchain and associated with each digital token. Each smart contract includes conditional logic defining restriction parameters, transfer conditions, and ownership rights. The smart contracts are encoded by the processor during token generation and validated prior to listing.

Consumer accounts 303 comprise data structures stored in a distributed ledger, each structure indexed by a unique user identifier. Each account includes metadata such as token balances, compliance status, and historical consumption metrics. The processor assigns digital tokens to these accounts following reward metric calculations.

CETEs 304 comprise digital tokens generated by the processor and assigned to consumer accounts. Each CETE includes a data structure representing underlying assets and an associated smart contract 302. CETEs are stored in a token registry and flagged as restricted until contract conditions are satisfied.

Exchange 305 comprises a private blockchain-based trading platform hosted on a secure computing node. The exchange includes a listing engine configured to register CETEs 304 for visibility to pre-authorized participants. The platform includes modules for smart contract enforcement, token transfer, and audit logging.

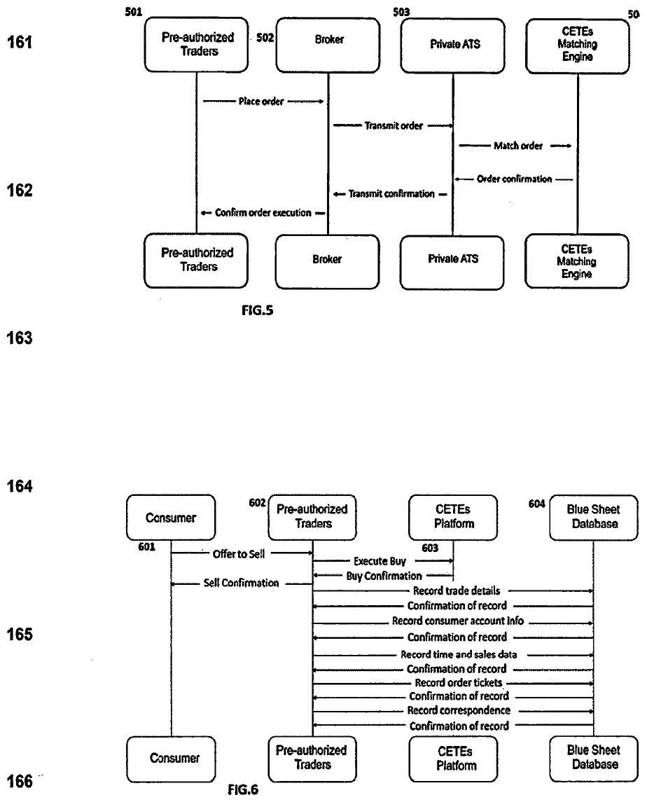

FIG. 4 is an embodiment of the automated consumer compliance methods leading to in-network consumer status 404. Upon request to participate on the CETEs platform 402 a consumer 401 identity is verified and other details and information are collected to ensure AML and KYC 403 compliance before CETEs can be assigned to a consumer account to be listed on the exchange. The compliance office 405 conducts ongoing internal audits of in-network consumer accounts to ensure compliance with laws.

Consumer 401 comprises a user device executing a registration interface configured to initiate onboarding procedures for participation in a digital asset infrastructure. The device includes a processor configured to transmit identity credentials and consumption history to a centralized compliance system.

Request to participate 402 comprises a structured data packet transmitted from the consumer device to a registration server. The packet includes metadata such as user identifier, device signature, and intent to join the CETE platform. The registration server parses the request and initiates compliance verification routines.

AML and KYC compliance module 403 comprises a software engine executing on a compliance server. The module is configured to verify identity credentials, cross-reference external databases, and apply anti-money laundering (AML) and know-your-customer (KYC) rules. The module outputs a compliance status flag for each user.

A registration interface executed by a computing device may be configured to receive legal documentation establishing a family unit or equivalent entity. The documentation may include verifiable legal guardianship records, family trust instruments, or jurisdiction-specific equivalents. Upon receipt, the processor parses the documentation and associates the verified family entity with a unique identifier. The system stores the identifier in a structured registry and enables combined expenditures tracking across all member accounts linked to the family entity. The compliance module 403 applies rule-based logic to validate the documentation against jurisdictional standards and updates the in-network consumer status 404 accordingly.

The computing system may further instantiate, generate, or otherwise display a governance dashboard associated with the family entity identifier. The governance dashboard comprises a graphical user interface rendered by a web-based or mobile application and configured to display consumption metrics, reward balances, and compliance status for each member account. The dashboard includes parental or guardian control modules configured to restrict access to sensitive financial data, approve or deny token disposition requests, and set spending thresholds for minor accounts. The compliance module 403 applies rule-based logic to validate the documentation against jurisdictional standards and updates the in-network consumer status 404 accordingly.

In-network consumer status 404 comprises a Boolean or enumerated value stored in a user profile database. The status is updated by the compliance module 403 following successful verification and is used to gate access to token assignment and exchange listing functions.

Compliance office 405 comprises a computing node configured to execute internal audit routines on consumer accounts. The node accesses historical consumption data, compliance logs, and smart contract metadata to evaluate ongoing eligibility. The audit results are stored in a secure ledger and may trigger alerts or restrictions.

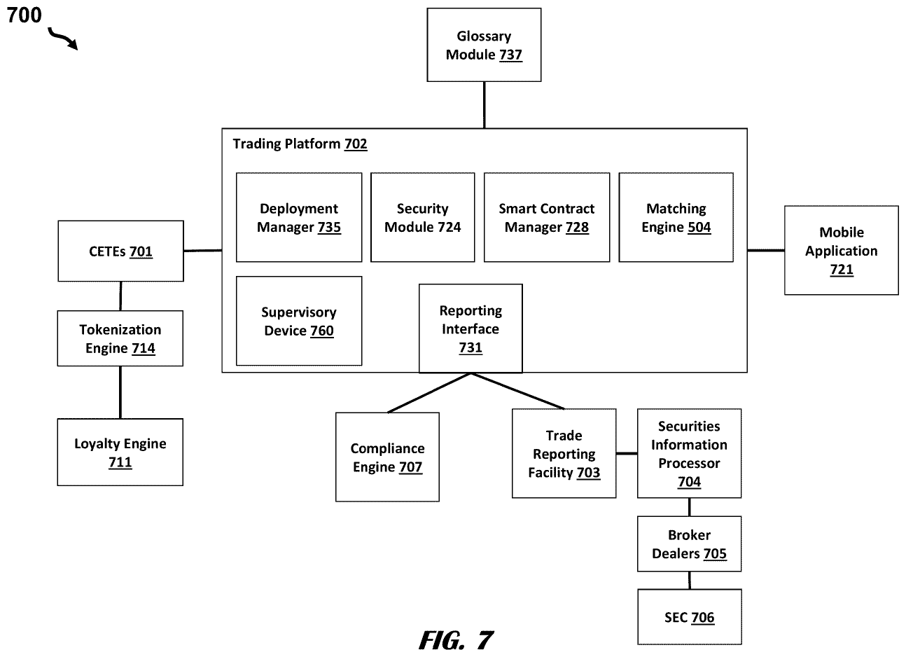

FIG. 5 is an embodiment of order flow of a pre-authorized trader 501 operating on a private platform 503. The platform's 503 broker transmits an order which is sent to the CETEs Matching Engine 504 after which the executed order is confirmed.

Pre-authorized trader 501 comprises a computing device operated by a credentialed participant authorized to access a private digital asset exchange. The device includes a secure trading interface configured to submit, modify, and confirm digital token orders in accordance with platform restrictions.

Private platform 503 comprises a blockchain-based trading system hosted on a secure computing node. The platform includes a processor configured to authenticate trader credentials, validate smart contract conditions, and route order instructions to a matching engine. The platform 503 may be implemented as a web-based or mobile-accessible application.

CETEs Matching Engine 504 comprises a software module executing on the private platform 503. The matching engine is configured to receive order instructions from pre-authorized traders, compare order parameters against available listings, and execute trades in accordance with smart contract restrictions. The engine includes a memory buffer for pending orders and a processor for executing matching logic.

FIG. 6 is an embodiment of a consumer 601 offering to sell a CETE(s) to pre-authorized traders 602 after restrictions have been satisfied on the platform 603. Details about the transaction are then recorded within the blue sheet database 604 for reporting purposes.

Consumer 601 comprises a computing device configured to execute a token management interface. The device includes a processor configured to initiate a token disposition request, transmit token metadata, and interact with smart contract verification modules hosted on a remote exchange platform.

Pre-authorized traders 602 comprise computing devices registered with the private exchange platform and configured to receive token listings from verified consumer accounts. Each device includes a secure trading interface and credential validation logic for accessing restricted asset listings.

Platform 603 comprises a private blockchain-based exchange system hosted on a secure computing node. The platform includes modules for smart contract enforcement, listing management, and token transfer execution. The processor of the platform 603 validates restriction conditions prior to enabling token disposition.

Blue sheet database 604 comprises a structured data store configured to record metadata associated with token disposition events. The database includes fields for timestamp, token identifier, trader identity, and compliance status. The processor writes disposition records to the database 604 for audit and reporting purposes.

FIG. 7 is an embodiment of a trading platform 702 having CETEs 701 performing an order reporting process to regulatory organizations. A dedicated Trade Reporting Facility 703 processes the data, and the Securities Information Processer 704 sends the fully processed data to brokers 705 in the order chain before submission to the Securities Exchange Commission 706.

The trading platform 702 includes hardware and software components configured to manage the listing, transfer, and reporting of CETEs 701, and further comprising a modular architecture that integrates multiple subsystems for regulatory compliance, token lifecycle management, and consumer engagement. The trading platform 702 interfaces with a compliance engine 707 configured to retrieve jurisdiction-specific (or region-specific) rule sets (e.g., compliance parameters) and apply machine learning algorithms to detect non-compliant behavior, triggering alert protocols. A loyalty engine 711 calculates goal-based reward metrics using entity-defined pledges and transmits fulfillment signals to a tokenization engine 714. The tokenization engine 714 constructs CETEs 701 using asset validation logic and metadata tagging. A matching engine 717 executes trades based on order book logic, while a credentialing module authenticates pre-authorized traders. A settlement engine performs clearing operations and a reporting module transmits trade data to a Trade Reporting Facility 703, which processes the data for submission to a Securities Information Processor 704. The Securities Information Processor 704 sends the fully processed data to brokers 705 in the order chain before submission to the Securities Exchange Commission 706. Additional modules include a mobile application interface 721, an API gateway, and a schema registry; a security module 724 with key management and audit trail logging; a smart contract manager 728 with lifecycle registry; a reporting interface 731 with scheduler and verification engine; a deployment manager 735 with jurisdictional overlays; and a glossary module 737 defining system terminology.

CETEs 701 comprise digital tokens generated by a tokenization engine executing on a secure computing node. Each CETE 701 includes a data structure representing one or more underlying assets and an associated smart contract encoded with restriction conditions. CETEs 701 are stored in a token registry and flagged for reporting upon disposition or transfer.

Each CETE 701 generated by the tokenization engine 714 may be classified as a restricted security under Regulation D exemptions, non-speculative by design. The smart contract manager 728 encodes restriction conditions that comply with Rule 506 of Regulation D, including limitations on resale, transferability, and investor accreditation. The processor flags each CETE 701 as non-speculative by design by associating the token with a consumer account 303 and preventing secondary market activity until the restriction conditions encoded in the smart contract have been satisfied. The CETEs 701 are not offered to the general public and are not intended for speculative trading. Rather, they are distributed privately to in-network consumers as a function of verified consumption activity and are only eligible for transfer to pre-authorized institutional or accredited investors via the private exchange platform 305. The exchange platform 305 enforces the encoded restrictions and limits token visibility and transferability to credentialed participants. The system stores compliance metadata in a token registry and transmits audit logs to regulatory endpoints 706 for reporting and oversight.

Trading platform 702 hosts a private blockchain-based exchange system configured to manage the listing, transfer, and reporting of CETEs 701. The platform includes a processor configured to enforce smart contract conditions, validate trader credentials, and route reporting data to regulatory endpoints.

Compliance engine 707 comprises a software module configured to interface with external regulatory databases via secure APIs. The module retrieves jurisdiction-specific rule sets and applies machine learning algorithms trained to detect anomalous patterns in consumption and transaction data indicative of non-compliance. Upon detection, the compliance engine 707 triggers a real-time alert protocol that transmits structured notifications to regulatory endpoints 706 via encrypted channels. The alert protocol includes metadata such as timestamp, entity identifier, rule violated, and severity index.

Loyalty engine 711 comprises a software module configured to associate consumer expenditures with goal-based reward metrics. The module accesses entity-defined goals such as crime reduction, literacy improvement, or community engagement. Loyalty engine 711 calculates reward eligibility based on consumer alignment with these goals and transmits pledge fulfillment signals to tokenization engine 714. Consumer dashboard 101 is updated with goal progress indicators, historical reward logs, and pledge status flags.

The loyalty engine 711 may be configured to receive pledge parameters from in-network entities defining reward conditions tied to societal goals. These parameters may include incentive weightings associated with crime reduction, literacy improvement, public health advancement, or carbon offset commitments. The processor applies a weighting algorithm to consumer expenditures based on alignment with these societal pledges. For example, a consumer purchase from an entity operating in a distressed community may receive a higher reward multiplier if the entity has committed to a crime reduction pledge. Similarly, purchases from entities supporting literacy programs or carbon reduction initiatives may be weighted to reflect the societal value of those contributions. The processor stores the pledge parameters in a structured database and applies the corresponding weightings during reward metric calculations executed by the tokenization engine 714.

Tokenization engine 714 further comprises a master basket constructor 714 configured to assemble CETEs 701 from selected underlying assets. The constructor 714 applies asset composition rules to validate regulatory compliance. Each CETE 701 is tagged with metadata including timestamp, wallet-style identifier, and asset provenance. A cloning module replicates master baskets for distribution to consumer accounts 303 based on reward metrics.

The tokenization engine 714 improves digital asset generation by applying asset composition rules and metadata tagging to construct CETEs 701. Each CETE includes a data structure representing one or more underlying assets and an associated smart contract encoded with restriction conditions. The smart contract manager 728 validates contract integrity and stores lifecycle metadata in a registry 729, enabling automated enforcement of asset restrictions and transfer conditions. This architecture eliminates manual oversight and reduces the risk of non-compliant asset distribution.

Matching engine 504 further comprises an order book manager 717 configured to maintain bid-ask records and execute trades using time-priority logic. A credentialing module authenticates pre-authorized traders 501 using multi-factor protocols and role-based access control. A settlement engine performs clearing operations and updates token registries. Trade data is formatted by a reporting module and transmitted to Trade Reporting Facility 703, Securities Information Processor 704, and SEC endpoint 706.

Mobile application 721 comprises a cross-platform interface compatible with iOS, Android, and web environments. The app includes modules for onboarding, token tracking, goal visualization, and compliance status. An API gateway exposes endpoints for third-party integration, including consumption data ingestion, reward calculation, and token disposition. Each endpoint adheres to defined schemas.

Security module 724 comprises a key management system configured to generate, store, and rotate cryptographic keys used for token custody. A storage repository stores restricted CETEs 701 until smart contract conditions are satisfied. An access control module enforces role-based permissions across system components and logs all access events in an audit trail ledger.

Smart contract manager 728 comprises a deployment engine configured to encode restriction conditions and compliance hooks into CETEs 701. Validation module 729 verifies contract integrity prior to listing. A contract registry stores lifecycle metadata including deployment timestamp, expiration date, and upgradability flags.

Reporting interface 731 comprises a data normalization engine configured to convert trade records into formats accepted by regulatory endpoints. The interface includes a submission scheduler and error handling module. A compliance verification engine cross-references submitted data with rule sets retrieved by compliance engine 707.

Deployment manager 735 comprises a configuration layer enabling jurisdiction-specific overlays. Templates define regulatory parameters, language localization, and economic integration logic. Modular architecture supports nation-scale rollout via containerized services and cloud orchestration. The deployment manager 735 enables jurisdiction-specific overlays through a modular configuration layer. Templates define regulatory parameters, language localization, and economic integration logic. This modular architecture supports nation-scale rollout via containerized services and cloud orchestration, improving adaptability and reducing implementation complexity across diverse regulatory environments.

The deployment manager 735 may be configured to instantiate a national overlay of the disclosed digital infrastructure over or alongside a nation-state's existing economic superstructure. The configuration layer includes jurisdiction-specific templates for integrating with national financial systems, regulatory frameworks, and public service platforms. The processor applies regionally defined parameters to allocate digital assets to in-network consumers based on consumption activity. The deployment manager 735 may further configure CETEs 701 as a parallel infrastructure for transparent wealth allocation to citizens. The processor may execute distribution routines that correlate verified consumption metrics with national policy objectives, including equitable wealth distribution, economic stimulus, or social inclusion. The modular architecture supports containerized deployment across cloud environments and enables real-time synchronization with national databases, including identity registries, tax systems, and social benefit platforms. The CETEs 701 may be flagged with metadata indicating their origin within the national overlay and may be subject to jurisdiction-specific restrictions encoded by the smart contract manager 728.

Glossary module 737 comprises a structured repository of system terminology including definitions for compliance engine 707, loyalty engine 711, tokenization engine 301, ATS 305, CETEs 701, and SRO 102. Each term is linked to its functional description and associated components to maintain consistency across documentation and implementation.

Trade Reporting Facility 703 comprises a computing module configured to receive trade data from the trading platform 702, normalize the data into a standardized format, and transmit the formatted data to downstream reporting systems. The module includes a processor and memory buffer for staging and validating trade records.

Securities Information Processor 704 comprises a computing system configured to aggregate trade data received from the Trade Reporting Facility 703. The processor of the Securities Information Processor 704 performs data integrity checks, timestamps each record, and prepares the data for submission to regulatory authorities.

Brokers 705 comprise computing devices registered with the exchange and configured to receive processed trade data from the Securities Information Processor 704. Each broker device includes a secure interface for reviewing, confirming, and forwarding trade records to compliance systems.

Securities Exchange Commission 706 comprises a regulatory endpoint configured to receive trade data submissions from broker systems. The endpoint includes a secure data ingestion interface and a compliance verification engine for evaluating submitted records against applicable regulatory standards.

The compliance engine 707 comprises a software module executing on a processor configured to retrieve jurisdiction-specific rule sets from external regulatory databases via secure APIs. The compliance engine 707 applies machine learning algorithms trained to detect anomalous patterns in consumption and transaction data indicative of non-compliance. Upon detection, the compliance engine 707 transmits structured alerts to regulatory endpoints 706 via encrypted channels. Each alert includes metadata such as timestamp, entity identifier, rule violated, and severity index.

The compliance engine 707 may evaluate operational metrics associated with registered entities and users against predefined thresholds stored in rule set database 104. A deviation from a predefined threshold 761 occurs when a monitored metric—such as transaction volume, pledge fulfillment rate, or behavioral score—falls outside an acceptable range defined by regulatory overlays. The compliance engine 707 applies rule-based logic and machine learning classifiers to detect such deviations. Upon detection, the compliance engine 707 generates a structured alert comprising metadata identifying the nature of the deviation, the affected entity or user, and the applicable rule set. The alert is transmitted to a supervisory computing device 760 for review and potential enforcement action.

The tokenization engine 714 comprises a software module executing on a secure computing node configured to construct digital tokens based on reward metrics. The tokenization engine 714 includes a master basket constructor configured to assemble CETEs 701 from selected underlying assets. The constructor applies asset composition rules to validate regulatory compliance. Each CETE 701 is tagged with metadata including timestamp, wallet-style identifier, and asset provenance. A cloning module replicates master baskets for distribution to consumer accounts 303.

The smart contract manager 728 comprises a deployment engine configured to encode restriction conditions and compliance hooks into CETEs 701. The smart contract manager 728 includes a validation module 729 configured to verify contract integrity prior to listing. A contract registry stores lifecycle metadata including deployment timestamp, expiration date, and upgradability flags. The smart contract manager 728 interfaces with the tokenization engine 714 and the blockchain interface 112 to enforce restriction conditions and record contract events.

The blockchain interface 112 comprises a distributed ledger system configured to record token generation, assignment, and transfer events. The blockchain interface 112 supports consensus operations including proof-of-stake and proof-of-work. The interface includes secure APIs for transmitting token metadata, compliance actions, and audit logs. Each transaction recorded on the blockchain includes a timestamp, token identifier, and compliance status.

Supervisory computing device 760 comprises a secure computing node configured to receive compliance alerts generated by compliance engine 707. Device 760 includes a processor, memory, and network interface configured to execute monitoring routines and display structured notifications. Device 760 may be operated by a regulatory authority, network administrator, or designated oversight entity. Upon receiving an alert, device 760 parses the alert payload to extract metadata including timestamp, entity identifier, rule violated, and severity index. Device 760 may store the alert in a compliance log, initiate follow-up actions, or transmit the alert to additional endpoints for escalation. Device 760 may also interface with audit trail ledgers and reporting interfaces 731 to generate summaries of compliance deviations across time intervals or jurisdictions.

FIG. 8 is a flowchart depicting operations of a computer-implemented method 800 for managing digital tokens based on consumption activity, according to embodiments. The method 800 comprises a sequence of executable operations performed by a computer, but may be implemented by one or more computing devices having one or more processors and software components configured to receive registration data, evaluate compliance, extract and parse usage records, calculate reward metrics, generate digital tokens, and record transactional data on a blockchain. Each operation corresponds to a discrete software routine or module within a computing system configured to support token lifecycle management, regulatory compliance, and secure data exchange across a private digital infrastructure. The operations depicted in FIG. 8 may be implemented as part of a software-as-a-service (Saas) platform and may be executed in real-time or batch mode depending on system configuration and jurisdictional requirements.

At operation 810, a computer receives registration data from a plurality of remote computing devices associated with entities and users via a network interface. Each data packet includes metadata identifying a user or entity, jurisdictional information, and device-specific credentials. The computer parses the packet and stores the extracted data in a memory buffer for compliance evaluation.

At operation 815, the computer verifies the registration data against region-specific compliance parameters stored in a rule set database. The computer accesses a rule set database storing region-specific compliance parameters. A rule-based evaluation engine executed by the computer compares the registration data against the stored parameters. The computer applies jurisdictional overlays to determine whether the registration data satisfies operational, legal, and behavioral thresholds required for participation in the digital infrastructure.

At operation 820, the computer generates a compliance profile for each entity and user whose registration data satisfies the compliance parameters. Each compliance profile comprises a unique identifier and a set of operational constraints. Upon determining that registration data satisfies compliance parameters, the computer generates a compliance profile. Each profile includes a unique identifier and a set of operational constraints. The computer stores the compliance profile in a structured registry accessible to other system modules.

At operation 825, the computer extracts usage records from a plurality of computing devices associated with consumption activity and declared contribution metrics. The computer extracts usage records from computing devices associated with consumption activity and declared contribution metrics. Each record includes timestamped entries representing purchases, pledges, or other economic behaviors. The computer retrieves the records via secure APIs and stores them in a staging buffer.

At operation 830, the computer parses the usage records to identify consumption values, timestamps, source identifiers, and contribution metrics. The computer parses the usage records to identify consumption values, timestamps, source identifiers, and contribution metrics. Parsing routines normalize the data into a standardized format compatible with reward calculation logic. The computer indexes the parsed data by user identifier and associates each record with the corresponding compliance profile.

At operation 835, the computer stores the parsed usage data in a structured database indexed by user identifier and time interval. The computer stores the parsed usage data in a structured database indexed by user identifier and time interval. The database schema supports efficient retrieval of consumption metrics for reward calculation and audit logging. The computer applies encryption protocols to protect sensitive data and enforces access control policies based on user roles.

At operation 840, the computer calculates a reward metric based on the parsed usage data that correlates consumption activity with token generation parameters. The computer calculates a reward metric based on the parsed usage data. The reward metric correlates consumption activity with token generation parameters defined by participating entities. The computer applies a mathematical model incorporating weighting factors derived from contribution metrics and entity pledges. The resulting reward metric determines the value and composition of the digital token to be generated.

At operation 845, the computer generates a digital token comprising a data structure and a smart contract encoded with conditional logic. The computer generates a digital token comprising a data structure and a smart contract encoded with conditional logic. A tokenization engine executed by the computer constructs the token payload using asset composition rules and metadata tagging. The smart contract includes restriction conditions governing transferability, ownership rights, and compliance obligations. The computer stores the token in a token registry and associates it with the corresponding user account.

At operation 850, the computer transmits the digital token to a private blockchain-based exchange platform hosted on a secure computing node. The computer transmits the digital token to a private blockchain-based exchange platform hosted on a secure computing node. The exchange platform includes modules for smart contract enforcement, credential validation, and token listing. The computer invokes listing routines that register the token for visibility to pre-authorized participants.

At operation 855, the records the usage records and compliance profiles on a blockchain. The computer records the usage records and compliance profiles on a blockchain. A blockchain interface executed by the computer supports consensus operations including proof-of-stake and proof-of-work. Each transaction includes metadata such as timestamp, token identifier, and compliance status. The computer writes the records to the blockchain ledger to provide auditability, immutability, and regulatory transparency.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1-20. (canceled)

21. A computer-implemented method executed for managing digital tokens based on consumption activity, the method comprising:
receiving registration data, wherein users may register as individuals or family units with verifiable guardianship or trust documentation; verifying the registration data against region-specific compliance parameters stored in a rule set database;
generating compliance profiles for entities and users;
extracting and parsing usage records to identify consumption values and contribution metrics;
storing parsed data in a structured database indexed by user identifier and time interval;
calculating reward metrics including family-unit aggregated expenditures;
generating a Consumer Earned Token (CETE) comprising a data structure and a smart contract encoded with restriction conditions and social-incentive hooks;
transmitting the CETE to a private blockchain-based exchange, wherein CETEs are initially owned by consumers and restricted from peer-to-peer trading until conditions are satisfied;
recording usage records and compliance profiles on a blockchain.

22. The method of claim 1, wherein a consumer registers as family units or an equivalent, with verifiable legal documentation and/or legal guardianship, family trust documentation or the international equivalents of the aforementioned documentation establishing a legal family entity or the equivalent for combined expenditures tracking.

23. The method of claim 1, wherein a software as a service system is configured to provide a computer-managed system that enables in-network entities to set terms and conditions for rewards through pledging to better control crime in distressed communities by enabling in-network consumer stake-holding within stated calendar periods, wherein the in-network entities perform a societal incentive weighting tied to crime reduction, literacy, health, or carbon pledges.

24. The method of claim 1, wherein a software as a service system is configured to provide a computer-managed system that enables a nation-state to overlay this novel digital infrastructure over or alongside its existing economic superstructure to better allocate the wealth of the nation to the in-network consumers who support the economy through consumerism.

25. The method of claim 1, wherein the CETEs are restricted securities under Regulation D exemptions, non-speculative by design.

26. A computer-implemented method executed for managing digital tokens based on consumption activity, the method comprising:
receiving, by a computer, registration data from a plurality of remote computing devices associated with entities and users via a network interface;
verifying, by the computer, the registration data against region-specific compliance parameters stored in a rule set database;
generating, by the computer, a compliance profile for each entity and user whose registration data satisfies the compliance parameters, wherein each compliance profile comprises a unique identifier and a set of operational constraints;
extracting, by the computer, usage records from a plurality of computing devices associated with consumption activity and declared contribution metrics;
parsing, by the computer, the usage records to identify consumption values, timestamps, source identifiers, and contribution metrics;
storing, by the computer, the parsed usage data in a structured database indexed by user identifier and time interval;
calculating, by the computer, a reward metric based on the parsed usage data that correlates consumption activity with token generation parameters;
generating, by the computer, a digital token comprising a data structure and a smart contract encoded with conditional logic;
transmitting, by the computer, the digital token to a private blockchain-based exchange platform hosted on a secure computing node; and
recording, by the computer, the usage records and compliance profiles on a blockchain.

27. The method of claim 26, further comprising:
executing, by the computer, a rule-based evaluation of operational metrics associated with the compliance profiles;
generating, by the computer, a compliance alert in response to detecting a deviation from a predefined threshold; and
transmitting, by the computer, the compliance alert to a supervisory computing device configured to receive compliance notifications.

28. The method of claim 27, further comprising:
retrieving, by the computer, updated compliance parameters from a remote data source hosted on a third-party server; and
updating, by the computer, the region-specific rule set stored in a local memory.

29. The method of claim 26, further comprising:
verifying, by the computer, identity credentials of a user using a multi-factor authentication protocol;
encrypting, by the computer, the verified identity credentials using a cryptographic algorithm; and
storing, by the computer, the encrypted identity credentials in a secure data store accessible to a compliance engine.

30. The method of claim 26, wherein the extracting the usage records from the plurality of computing devices includes:
receiving, by the computer, usage data from a point-of-interaction device;
parsing, by the computer, the usage data to identify a source identifier, a timestamp, and a consumption value; and
associating, by the computer, the parsed usage data with a user identifier.

31. The method of claim 26, wherein the calculating the reward metric includes:
executing, by the computer, a mathematical model that applies a weighting factor to the consumption value based on a declared contribution metric associated with an entity; and
generating, by the computer, a reward metric based on the weighted consumption value.

32. The method of claim 26, wherein the generating digital token includes:
assembling, by the computer, a digital token comprising a data structure and a smart contract;
encoding, by the computer, the smart contract with a restriction condition; and
assigning, by the computer, the digital token to a user account stored in a distributed ledger.

33. The method of claim 26, further comprising:
executing, by the computer, a verification of a restriction condition associated with the digital token; and
enabling, by the computer, the digital token to be listed on a private blockchain-based exchange platform hosted on a secure computing node in response to the restriction condition being satisfied.

34. The method of claim 26, further comprising:
recording, by the computer, a digital token event on a blockchain using a consensus operation selected from the group consisting of proof-of-stake and proof-of-work.

35. The method of claim 26, further comprising:
generating, by the computer, an audit log comprising a timestamp, a token identifier, and a compliance status; and
recording, by the computer, the audit log on a blockchain.

36. A system for managing digital tokens based on consumption activity, the system comprising:
a computer comprising a processor, configured to:
receive registration data from a plurality of remote computing devices associated with entities and users via a network interface;
verify the registration data against region-specific compliance parameters stored in a rule set database;
generate a compliance profile for each entity and user whose registration data satisfies the compliance parameters, wherein each compliance profile comprises a unique identifier and a set of operational constraints;
extract usage records from a plurality of computing devices associated with consumption activity and declared contribution metrics;
parse the usage records to identify consumption values, timestamps, source identifiers, and contribution metrics;
store the parsed usage data in a structured database indexed by user identifier and time interval;
calculate a reward metric based on the parsed usage data that correlates consumption activity with token generation parameters;
generate a digital token comprising a data structure and a smart contract encoded with conditional logic;
transmit the digital token to a private blockchain-based exchange platform hosted on a secure computing node; and
record the usage records and compliance profiles on a blockchain.

37. The system of claim 36, wherein the computer is further configured to:
execute a rule-based evaluation of operational metrics associated with the compliance profiles;
generate a compliance alert in response to detecting a deviation from a predefined threshold; and
transmit the compliance alert to a supervisory computing device configured to receive compliance notifications.

38. The system of claim 36, wherein the computer is further configured to:
retrieve updated compliance parameters from a remote data source hosted on a third-party server; and
update the region-specific rule set stored in the rule set database.

39. The system of claim 36, wherein the computer is further configured to:
verify identity credentials of a user using a multi-factor authentication protocol;
encrypt the verified identity credentials using a cryptographic algorithm; and
store the encrypted identity credentials in a secure data store accessible to a compliance engine.

40. The system of claim 36, wherein the computer is further configured to:
receive usage data from a point-of-interaction device;
parse the usage data to identify a source identifier, a timestamp, and a consumption value; and
associate the parsed usage data with a user identifier.
